(19) United States
(12) Patent Application Publication
(10) Pub. No.: US 2003/0079576 A1
(43) Pub. Date: May 1, 2003

(54) Pliers having ratchet fastening mechanism

(76) Inventor: Meei Feng Lo, Taichung City (TW)

Correspondence Address: PRO-TECHTOR INTERNATIONAL, 20775 Norada Court, Saratoga, CA, 95070-3018, US

(21) Appl. No.: 10/039,917

(22) Filed: Oct. 25, 2001

(51) Int. Cl. B25B 7/14

(52) U.S. Cl. 81/318

(57) ABSTRACT

A fastening mechanism mounted in a pair of pliers comprises a pawl mechanism including an internal gear member and peripheral latched pieces, a peripheral ratchet inside a hole in one pliers with pawl mechanism disposed therein for catching and holding one of the latched pieces in a first position, a pivot joint having a circumferential gear member meshed with the gear member of pawl mechanism, an elastic member put on the joint, and a fastening member urged by the elastic member being secured to the joint. In gripping, the pawl mechanism is allowed to move in only one direction such that a release of the gripping on handles does not disengage a gripped object from the jaws in a second position. In releasing, press the fastening member to compress the elastic member for disengaging the pawl mechanism from the ratchet prior to returning to the first position once compression of the elastic member is released.

### FIELD OF THE INVENTION

The present invention relates to pliers-type hand tools and more particularly to a pair of pliers having ratchet fastening mechanism.

### BACKGROUND OF THE INVENTION

A conventional pliers is shown in FIG. 1 comprising a pair of jaws 1, a pivot joint 2, and a torsion spring 3 anchored within pliers. In use, user may hold handles to grip an object between undulated gripping surfaces at the open ends of jaws 1. However, the previous design suffered from several disadvantages. For example, the elasticity of torsion spring 3 may degrade as time passes. Further, a sudden careless release of gripping force on handles may cause the object to drop from jaws 1. Thus improvement exists.

### SUMMARY OF THE INVENTION

It is therefore an object of the present invention to provide a fastening mechanism mounted in a pair of first and second pliers comprising an aperture formed in the second pliers; a cylindrical pawl mechanism including a stage bore, an internal gear member formed on an upper surface of the bore, and a plurality of peripheral latched pieces; a peripheral ratchet inside a hole in the first pliers with the pawl mechanism disposed therein so as to catch and hold one of the latched pieces in a first position; a joint for pivotably coupling the pliers and having a circumferential gear member meshed with the gear member of the pawl mechanism in the first position wherein the joint inserts through the aperture and the bore of the pawl mechanism; an elastic member put on the joint; a fastening member urged by the elastic member being releasably secured to the joint; and a torsion spring anchored between the pliers; wherein in an operation of gripping an object between jaws of the pliers, the torsion spring is compressed, the pawl mechanism is allowed to move in only a first direction such that a release of the gripping on handles of the pliers does not disengage the object from the jaws in a second position; and in an operation of releasing the object, the fastening member is operative to compress the elastic member so as to disengage the gear member of the joint from the gear member of the pawl mechanism, disengage the pawl mechanism from the ratchet, and expand the torsion spring for returning to the first position once the compression of the elastic member is released.

The above and other objects, features and advantages of the present invention will become apparent from the following detailed description taken with the accompanying drawings.

### BRIEF DESCRIPTION OF THE DRAWINGS

FIG. 1 is a plan view of a conventional pliers;

FIG. 2 is an exploded view of a preferred embodiment of pliers according to the invention;

FIG. 3 is a plan view in part section of the assembled pliers;

FIG. 4 is cross-sectional view illustrating a ratchet fastening mechanism of the pliers of FIG. 2 in an engaged position;

FIG. 5 is a view similar to FIG. 3 where an object is gripped by jaws; and

FIG. 6 is a view similar to FIG. 4 where ratchet fastening mechanism is in an unlocked position.

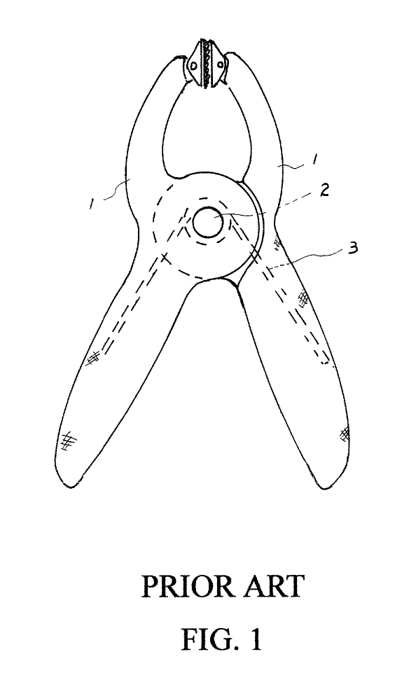

### DETAILED DESCRIPTION OF THE PREFERRED EMBODIMENTS

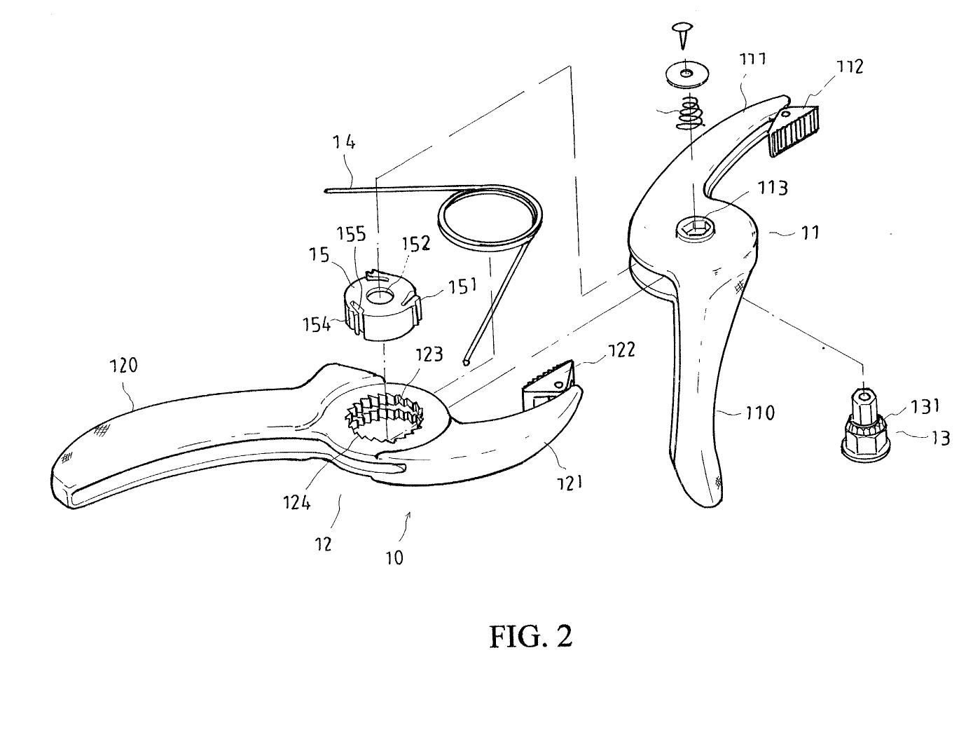

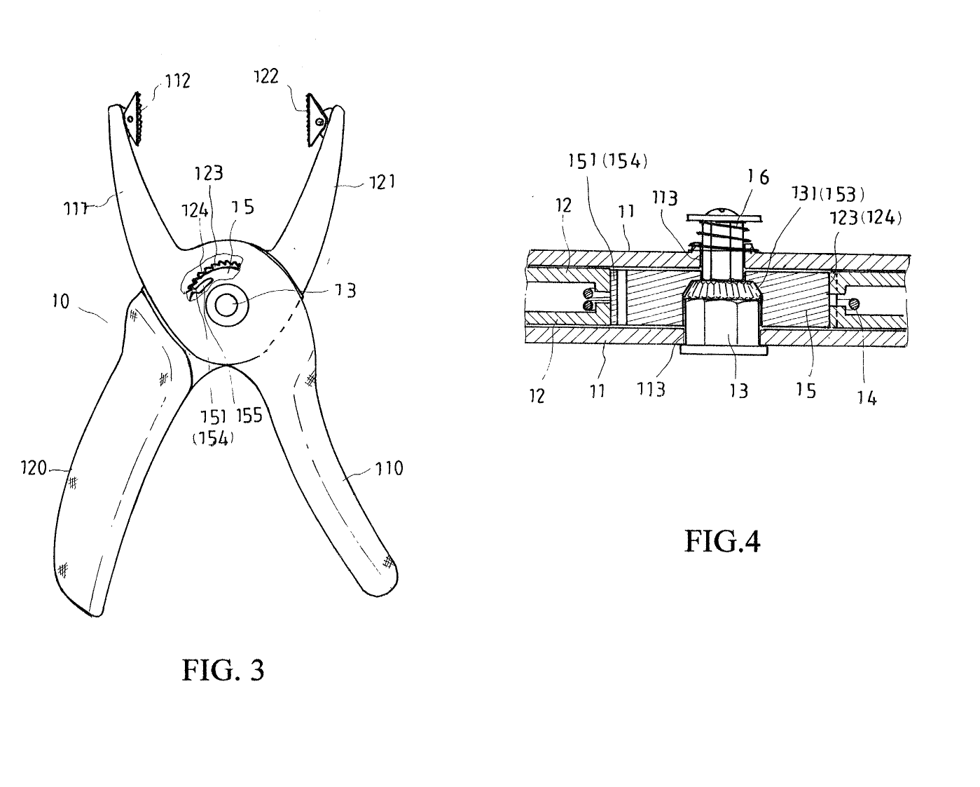

Referring to FIGS. 2 to 4, there is shown a pair of pliers 11 and 12 constructed in accordance with the invention comprising a pair of handles 110 and 120, a pair of jaws 111 and 121 having undulated gripping surfaces 112 and 122, a pivot joint 13 having a circumferential gear member 131 having sloped teeth, a cylindrical pawl mechanism 15 including a stage bore 152, an internal gear member 153 formed on the upper surface of bore 152 having corresponding sloped teeth so as to mesh with gear member 131 in a normal position, and a plurality of latched pieces 151 evenly formed on edge being spaced from a body of the pawl mechanism 15 by a cavity 155, each latched piece 151 having a tooth 154 on an outer side, a ratchet 124 formed on circumferential surface of hole 123 in the other pliers 12 with pawl mechanism 15 disposed therein so as to catch and hold a tooth 154 of one of latched pieces 151 in a normal position, a polygonal aperture 113 formed in one pliers 11 so that the polygonal head of pivot joint 13 may insert through aperture 113, bore 152 of pawl mechanism 15, and a spring 16 for being secured by a washer and a screw, and a torsion spring 14 anchored between pliers 11 and 12 with a center around ratchet 124.

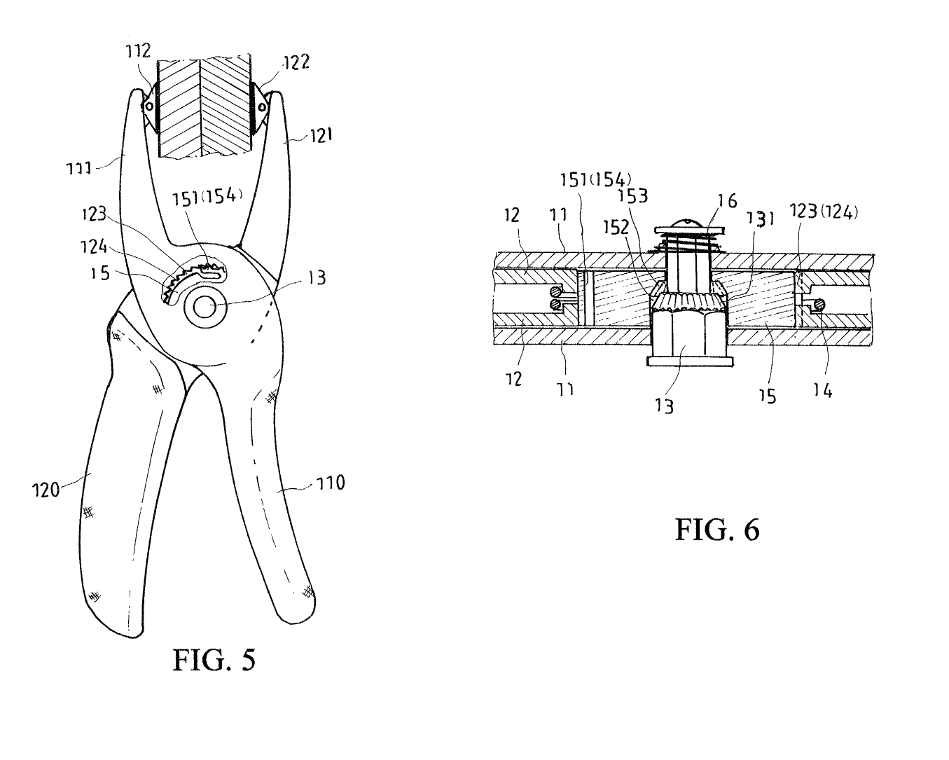

Referring to FIG. 5, in use user may hold handles 110 and 120 to grip an object between undulated gripping surfaces 112 and 122 at the open ends of jaws 111 and 121. During this gripping process, torsion spring 14 is compressed. Further, pawl mechanism 15 is allowed to move in only one direction. In other words, the opposite movement of pawl mechanism 15 is prevented. Once the object is held firmly between undulated gripping surfaces 112 and 122 a release of gripping force on handles 110 and 120 may not cause the object to drop from jaws 111 and 121 due to the provision of ratchet fastening mechanism. This is one of advantageous benefits of the invention.

Referring to FIG. 6, the releasing operation after finishing a job will now be described. User may press screw and washer to compress spring 16. As a result, gear member 131 of pivot joint 13 becomes disengaged from gear member 153 of pawl mechanism 15. Also, pawl mechanism 15 becomes disengaged from ratchet 124. Hence, a release of gripping force on handles 110 and 120 may cause the object to drop from jaws 111 and 121 by the expansion of torsion spring 14. In view of this, the releasing operation of pliers (i.e., returned to unlocked position) is quick and simple. This is another advantageous benefit of the invention.

While the invention has been described by means of specific embodiments, numerous modifications and variations could be made thereto by those skilled in the art without departing from the scope and spirit of the invention set forth in the claims.

What is claimed is:

1. A fastening mechanism mounted in a pair of first and second pliers comprising:
an aperture formed in the second pliers;
a cylindrical pawl mechanism including a stage bore, an internal gear member formed on an upper surface of the bore, and a plurality of peripheral latched pieces;
a peripheral ratchet inside a hole in the first pliers with the pawl mechanism disposed therein so as to catch and hold one of the latched pieces in a first position;
a joint for pivotably coupling the pliers and having a circumferential gear member meshed with the gear member of the pawl mechanism in the first position wherein the joint inserts through the aperture and the bore of the pawl mechanism;
an elastic member put on the joint;
a fastening member urged by the elastic member being releasably secured to the joint; and
a torsion spring anchored between the pliers;
wherein in an operation of gripping an object between jaws of the pliers, the torsion spring is compressed, the pawl mechanism is allowed to move in only a first direction such that a release of the gripping on handles of the pliers does not disengage the object from the jaws in a second position; and in an operation of releasing the object, the fastening member is operative to compress the elastic member so as to disengage the gear member of the joint from the gear member of the pawl mechanism, disengage the pawl mechanism from the ratchet, and expand the torsion spring for returning to the first position once the compression of the elastic member is released.

2. The fastening mechanism of claim 1, wherein the gear member of the pawl mechanism has sloped teeth and the gear member of the joint has corresponding sloped teeth.

3. The fastening mechanism of claim 1I wherein each of the latched pieces comprises a cavity for spacing the latched piece from the pawl mechanism and a tooth on an outer side disposed corresponding to one of a plurality of teeth of the ratchet.
